(19) United States
(12) Patent Application Publication
(10) Pub. No.: US 2014/0109728 A1
(43) Pub. Date: Apr. 24, 2014

(54) TIRE LEVER KIT

(71) Applicant: Robert Grant McRorie, III, Huntersville, NC (US)

(72) Inventor: Robert Grant McRorie, III, Huntersville, NC (US)

(21) Appl. No.: 14/057,926

(22) Filed: Oct. 18, 2013

Related U.S. Application Data
(60) Provisional application No. 61/715,679, filed on Oct. 18, 2012.

(51) Int. Cl. B60C 25/02; B60S 5/04

(52) U.S. Cl. CPC B60C 25/02; B60S 5/04
USPC 81/15.2; 157/1.3

(57) ABSTRACT

The present invention provides a device for repairing bicycle tires that includes a canister of compressed gas and a tool for removing tires. The tool includes a bit for prying a tire bead and a housing that is configured to engage the canister. The tool can be detached from the canister. In this manner a lightweight, aerodynamic device for repairing a tire is provided.

### FIELD OF THE INVENTION

The invention relates generally to repair kits for bicycles and more specifically to a lightweight device for changing a tire.

### BACKGROUND OF THE INVENTION

Cyclists carry repair kits. During races such kits are preferably lightweight and aerodynamic. Conventional repair kits can include a spare inner tube, a tool to facilitate removal of a tire and replacement of the tube. A device for inflating a tire such as a pump for inflating a tire or a cartridge of compressed gas such as carbon dioxide, CO₂. Other tools such as wrenches and spoke tighteners can also be included in a repair kit. For some cyclists, it is important that a repair kit weigh as little as possible and be configured to minimize wind drag. In this regard, a lightweight, aerodynamically configured kit can provide for much higher speeds for competitive cyclists such as those in road races or the cycling leg of a triathlon.

Conventionally, such repair kits are contained in pouches that are stored below and to the rear of the bicycle seat. Some kits are pouchless, and in these kits the components of the kit are attached to the bicycle either directly or via a bracket or bracket/adapter combination.

A problem with pouchless kits is that it can be difficult to mount all of the desired components of the kit without increasing the weight of the kit.

Another problem with conventional kits is that they constitute extra weight for the cyclist to transport.

Another problem with conventional pouchless kits is that the irregular surfaces of tools exposed to the wind can cause drag that the cyclist must overcome.

Another problem with conventional kits is that removal of a tool and replacement of a tool within the kit can be time consuming, particularly with regard to race conditions.

### SUMMARY OF THE INVENTION

The present invention addresses these problems by providing a device for changing a tire that is configured to reduce aerodynamic drag and weight of a bicycle repair kit. More specifically, there is provided a device that is configured to include both the functions of a tire removal tool and a compressed gas canister. In an alternative embodiment, the device is configured to also include an inflator nozzle.

According to one embodiment of the present invention, there is provided a device for repairing bicycle tires. The device includes a canister of compressed gas, and a tool for removing tires.

According to one aspect of the present invention, the tool includes a bit for prying head and a housing that is configured to engage the canister.

According to one aspect of the present invention, the tool is configured to be detached from the canister of compressed gas.

According to one aspect of the present invention, the tool is configured such that the housing can be utilized as a lever when the tool is not engaged with the canister.

According to one aspect of the present invention, the housing is configured such that it cannot be effectively utilized as a lever when the tool is not engaged with the canister.

According to one aspect of the present invention, the canister and the housing together are configured to be utilized as a lever when the tool is used for removing tires.

According to one aspect of the present invention, the tool is attached to the canister such that the canister and the tool together form a tire lever.

According to another embodiment of the present invention, there is provided a tire lever that includes a tool portion configured to engage a tire attached to a rim such that the tire can be moved to disengage a bead portion of the tire from the rim. The tire lever also includes a canister. The tool is attached to the canister such that the canister forms the handle of a tire lever.

### BRIEF DESCRIPTION OF THE DRAWINGS

For a fuller understanding of the nature and objects of the present invention, reference should be made to the following detailed description taken in connection with the accompanying drawings, wherein:

FIG. 1 is a side view of a first configuration of a kit that includes a device for changing a tire according to one embodiment of the present invention wherein the kit is attached to a bicycle seat post;

FIG. 2 is a side view of a second configuration of a kit that includes a device for changing a tire according to the embodiment shown in FIG. 1 wherein the kit is attached to a bicycle seat post;

FIG. 3 is a perspective view of a third configuration of a kit that includes a device for changing a tire according to the embodiment shown in FIG. 1 wherein the kit is attached to a bicycle seat post;

FIG. 4 is a perspective view of the device for changing a tire shown in FIGS. 1-3 taken from a tire-inflating end;

FIG. 5 is a perspective view of the device for changing a tire shown in FIG. 4 taken from the tire lever end and showing the device rotated 180 degrees along a horizontal axis relative to the depiction in FIG. 4;

FIG. 6 is a side view of a device for changing a tire according to according to the embodiment of the invention shown in FIG. 4 wherein a gas cylinder is shown in hidden lines;

FIG. 7 is a top view of the device for changing a tire according to the embodiment of the invention shown in FIG. 4 wherein a gas cylinder is shown in hidden lines;

FIG. 8 is a bottom view of the device for changing a tire according to the embodiment of the invention shown in FIG. 4 wherein a gas cylinder is shown in hidden lines;

FIG. 9 is an end view of the device for changing a tire according to the embodiment of the invention shown in FIG. 4;

FIG. 10 is a sectioned side view of the device for changing a tire according to the embodiment of the invention shown in FIG. 4 taken along line 10-10 of FIG. 7 wherein a gas cylinder is shown in hidden lines;

FIG. 11A is a perspective view of a device for changing a tire according to an alternative embodiment of the invention wherein a gas cylinder is shown in hidden lines;

FIG. 11B is a perspective view of a device for changing a tire according to the alternative embodiment shown in FIG. 11A wherein a gas cylinder is shown in hidden lines;

FIG. 12A is a perspective view of a device for changing a tire according to an alternative embodiment of the invention wherein a gas cylinder is shown in hidden lines;

FIG. 12B is a perspective view of a device for changing a tire according to the alternative embodiment shown in FIG. 12A wherein a gas cylinder is shown in hidden lines;

FIG. 13A is a top view of a device for changing a tire according to an alternative embodiment of the invention wherein a gas cylinder is shown in hidden lines;

FIG. 13B is a side view of a device for changing a tire according to the alternative embodiment shown in FIG. 13A wherein a gas cylinder is shown in hidden lines; and

FIG. 13C is a bottom view of a device for changing a tire according to the alternative embodiment shown in FIG. 13A where a gas cylinder is shown in hidden lines.

### DETAILED DESCRIPTION OF THE PREFERRED EMBODIMENTS

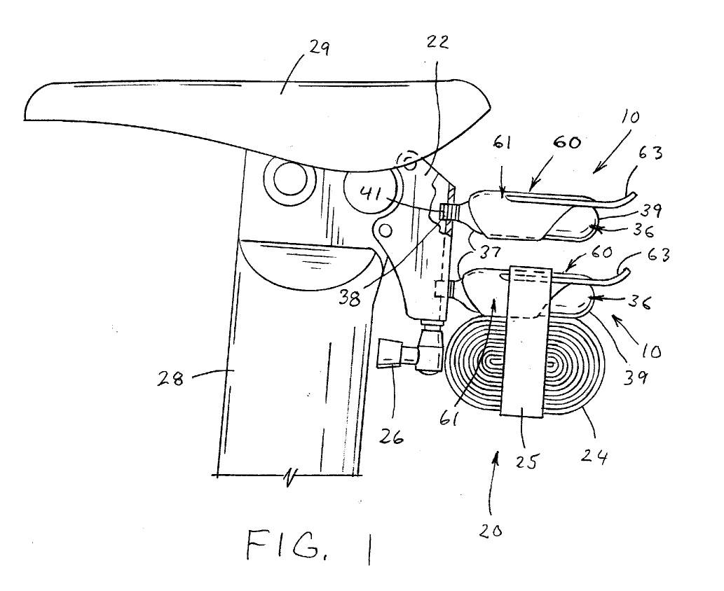

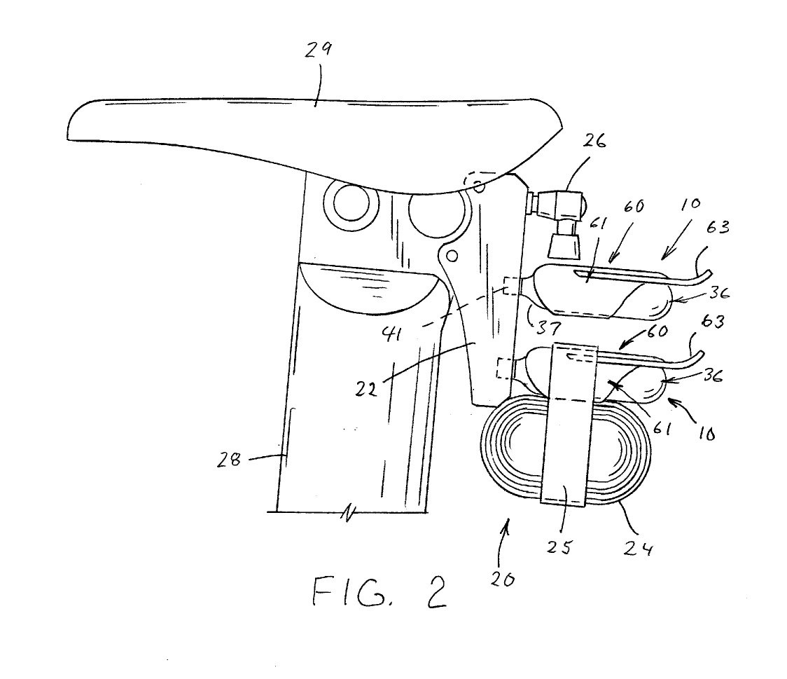

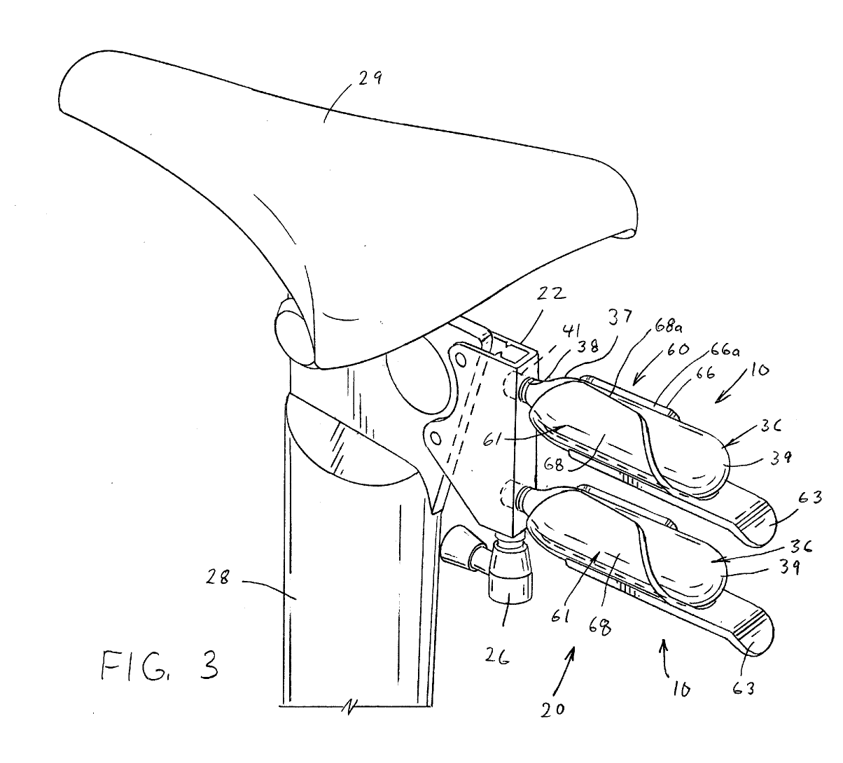

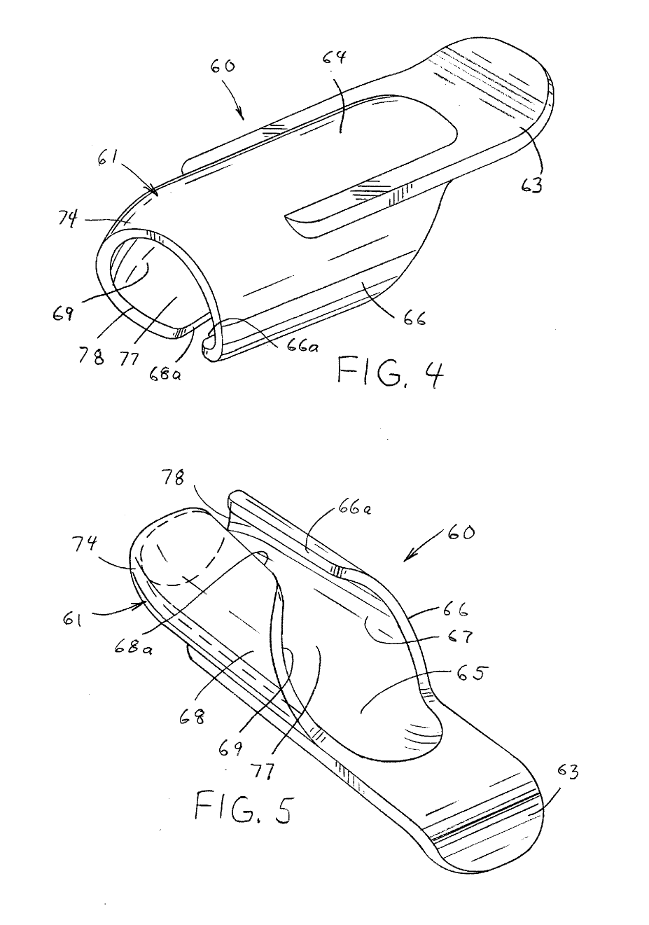

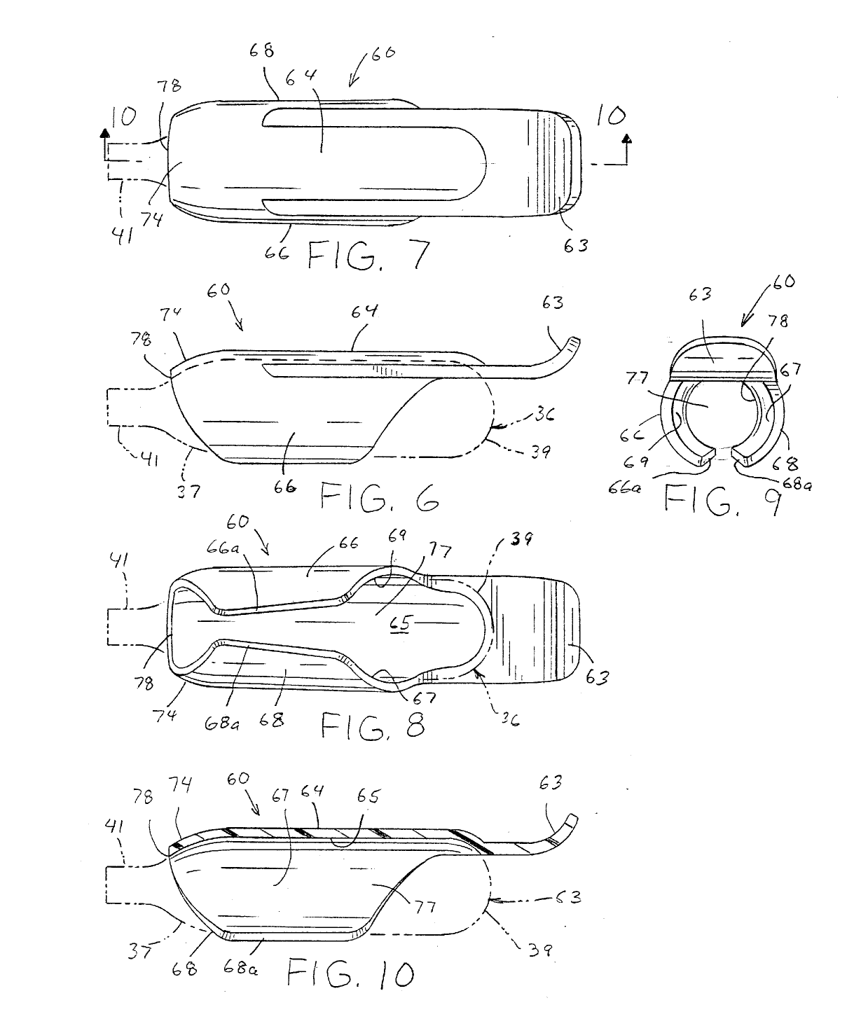

Embodiments of the present invention are directed to a combined tire removal and inflating device 10 for disengaging and engaging a portion of a tire with a rim and for inflating a tire. As can be seen in the embodiment shown in FIG. 1, device 10 is included within a kit 20 that includes a bracket 22, an inner tube 24, and an inflator nozzle 26. Kit 20 is configured to be attached to a bicycle via a seat post 28 that supports a bicycle seat 29. In this manner, kit 20 provides for a streamlined and relatively light package of tools for repair of a bicycle. It is believed that kit 20 will be used by cyclists competing in races and, in particular, by cyclists competing in triathlons.

Referring now to FIG. 1, the present invention provides combined tire removal and inflating device 10 that includes a compressed gas cartridge 36 and a tire-removal tool 60. Cartridge 36 includes a generally cylindrical body that has two generally rounded ends: a first end 37 and a second end 39. A neck 41 extends from first end 37 and includes a threaded tip 38. Tip 38 is configured to removably engage an inflator nozzle 26 such that the contents of cartridge 36 can be discharged from cartridge 36 and transferred into a tire. In one embodiment, compressed gas cartridge 36 contains compressed carbon dioxide, CO₂. Inflator nozzle 26 is configured to be attached to an inner-tube 24 of a bicycle tire as is commonly understood. In this regard, cartridge 36 is configured to be used to inflate a bicycle tire.

Continuing to refer to FIG. 1 which illustrates a first embodiment of the present invention, tool 60 includes a body 64. A prying bit 63 extends from body 64 and is configured to be positioned between a bicycle wheel rim and a bicycle tire. Bit 63 is configured such that such that the tire removal device 10 can be used to pry a bead of the bicycle tire away from and outside of the wheel rim and can be used to lever the bead edge of a tire such that it is received within an annular channel defined by the rim. In this manner a tire can be disengaged and engaged with the rim by use of device 10 as discussed further below.

Tool 60 also includes a housing 61 that is defined by body 64 and walls 66 and 68 that extend from body 64. Walls 66 and 68 extend from body 64 to edges 66a and 68a respectively. Wall 66 has an interior surface 67, wall 68 has an interior surface 69, and body 64 has an interior surface 65. Together these surfaces define an interior space 77. Interior space 77 is configured to receive cartridge 36. Surfaces 65, 67, and 69 are configured such that cartridge 36 is at least partially retained within space 77 by interaction of corresponding surface geometries defined by housing 61 and cartridge 36. In this regard, inner surface 65 of body 64 is configured such that surface 65 defines a curved space that wraps up and around portions of the curved first end 37 and second end 39 of cartridge 36. It is believed that friction between interior surfaces 65, 67, and 69 and cartridge 36 also acts to retain cartridge 36 within space 77. In other embodiments, housing 61 and cartridge 36 are configured such that cartridge 36 is retained within interior space 77 by friction alone.

Housing 61 has a first end 74 that is generally cup shaped and has an opening 78 defined therein. In the illustrated embodiment, opening 78 has a discontinuous perimeter such that opening 78 is substantially U-shaped. In other embodiments, opening 78 is defined on all sides by housing 61 such that opening 78 is substantially circle-shaped. Opening 78 is configured to receive the neck portion of cartridge 36 extending therethrough. In this manner, threaded tip 38 is exposed such that it can be engaged with inflator nozzle 26 or a bracket 22.

By way of example and not limitation, tool 60 can be formed of one of the following: wood, metal, polycarbonate, Acrylonitrile butadiene styrene, polypropylene, polyester, nylon, carbon fiber, other polymeric material and a combination thereof. It should be appreciated that tool 60 is configured to flex as required to provide for insertion of cartridge 36 within space 77 and to provide for the removal of cartridge 36 from within space 77. In addition, tool 60 is configured to be sufficiently stiff to cartridge 36 within space 77.

In one embodiment, bracket 22 is configured to threadingly engage tip 38 such that device 10 is retained and supported by bracket 22. In another embodiment, bracket 22 includes a hole or opening configured to receive tip 38 without retaining tip 38. In such an embodiment, bracket 22 functions to position device 10 and cartridge 36 is retained by an adapter or slip-on connector positioned the tip 38. Bracket 22 is configured to be attached to a seat post 28 that is configured to attach seat 29 to a bicycle (not shown) and support it thereon. Tool 60 is configured and opening 78 is configured such that tool 60 cannot be removed from cartridge 36 when tip 38 is connected to bracket 22 or nozzle 26.

The present invention can be better understood by a description of the operation thereof. To ready device 10 for use, it is first assembled by positioning tool 60 and gas cartridge 36 relative to each other such that neck 41 of cartridge 36 extends through opening 78 and the body of cartridge 36 is received within the interior space defined by housing 61. The two components are engaged by pushing cartridge 36 and housing 61 together such that cartridge 36 is retained therein.

In one embodiment, tool 60 is dimensioned such that it does not have sufficient mechanical integrity to be used as a tire lever. In this regard, cartridge 36 is configured to provide the mechanical strength for device 10 to be operable as a tire lever. In such an embodiment, housing 61 is configured to attach prying bit 63 to cartridge 36 such that cartridge 36 functions as a lever or handle for prying bit 63. In this embodiment, device 10 is operable both to remove a tire and for inflating an innertube. In another embodiment, tool 60 is dimensioned such that it can be used independently of cartridge 36 as a tire lever. If using tool 60 independently of cartridge 36, cartridge 36 is removed 60 such that device 10 is disassembled. The operation of the present invention will now be described with reference to tool 60. It should be understood that when used to remove a tire, the operation of device 10 is substantially the same as that of tool 60 and can be understood from a description of the operation of tools 60.

When repairing a flat tire, a triathlete or other user first disengages device 10 including cartridge 36 and tool 60 from bracket 22. If a spare inner tube 24 is attached to device 10 with a band 25, inner tube 24 is removed from device 10. In one embodiment, band 25 can be a strap fastened with hook and loop fastener. Tool 60 and cartridge 36 are separated. Then the user inserts bit 63 between the tire and the rim as is commonly understood. Tool 60 is subsequently manipulated such that a bead portion of the tire is lifted clear of the rim and moved out of the annular channel defined by a tire rim. Tool 60 is then moved radially along the rim such that additional portions of the bead are removed. In this manner the entire circumference of bead is removed from the annular channel such that defective tube 24 is accessible. In one embodiment, a second tool 60 is inserted between the bead and the rim after the bead is initially separated from the rim and moved away from the first tool 60 to completely disengage the bead from the rim. Once the defective tube is accessible, i.e. the bead is clear of the rim, the defective tube is removed and repaired or replaced. After the defective tube 24 is repaired and reinserted into the channel defined by the rim or replaced with a spare tube 24, the user then uses the prying bit 63 of device 10 to seat the bead of the tire within the annular channel defined by the rim. The tire is then inflated by attaching cartridge 36 to tube 24 that is within the tire via inflator nozzle 26. Inflator nozzle 26 is then activated such that the inner tube is inflated when gas is transferred from cartridge 36 to inner tube 24.

During the inflation process, the temperature of cartridge 36 is reduced as a function of the thermodynamic properties of the gas as it expands as it exits cartridge 36. In this regard, it is preferable that the material chosen to form housing 61 be operable as a thermal insulator such that the user is protected from discomfort or injury caused by the rapid decrease in temperature of cartridge 36. In this regard, housing 61 is operable as a grip or holder for cartridge 36 and protects the user's hands from the cold temperatures created by inflating tube 24 with cartridge 36. In this regard, it is unexpectedly advantageous to use device 10 to inflate an inner tube.

In an embodiment inflator nozzle 26 is attached to device 10 via threaded tip 38 at all times. In other words, nozzle 26 is attached to device 10 when it is being stored on the receiver as well as when device 10 is being used to change and inflate a tire.

In another alternative embodiment, a thermoplastic over-molded grip material is included on tool 60. The grip material will be positioned such that it can be configured to ensure that tool 60 does not spin relative to cartridge 36 when device 10 is be engaged with or dis-engaged from the bracket or the nozzle.

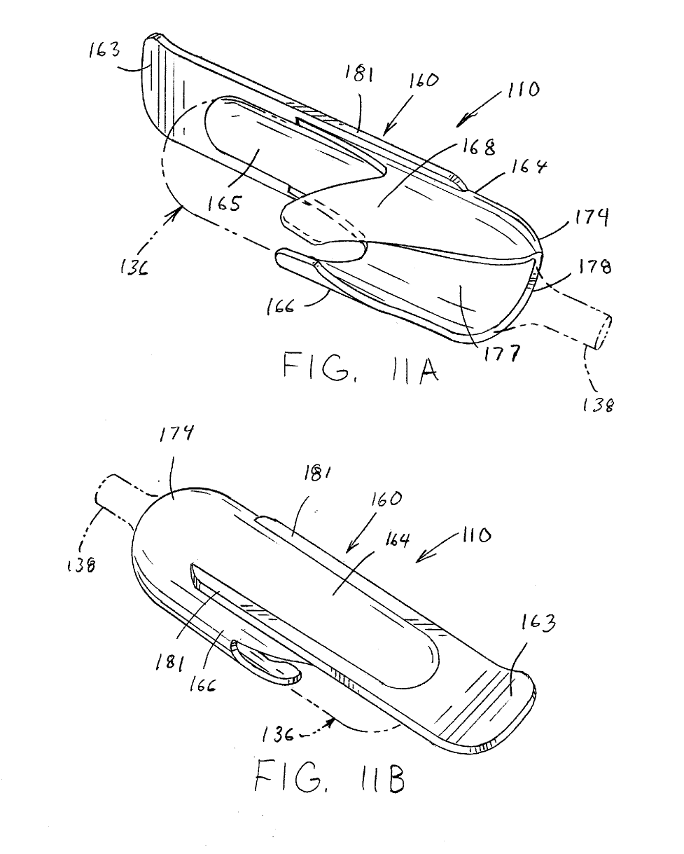

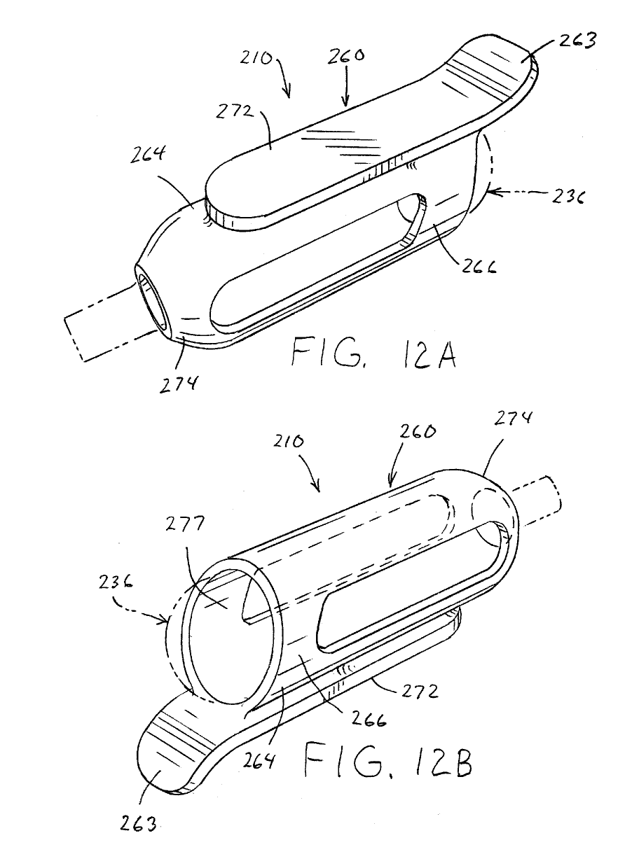

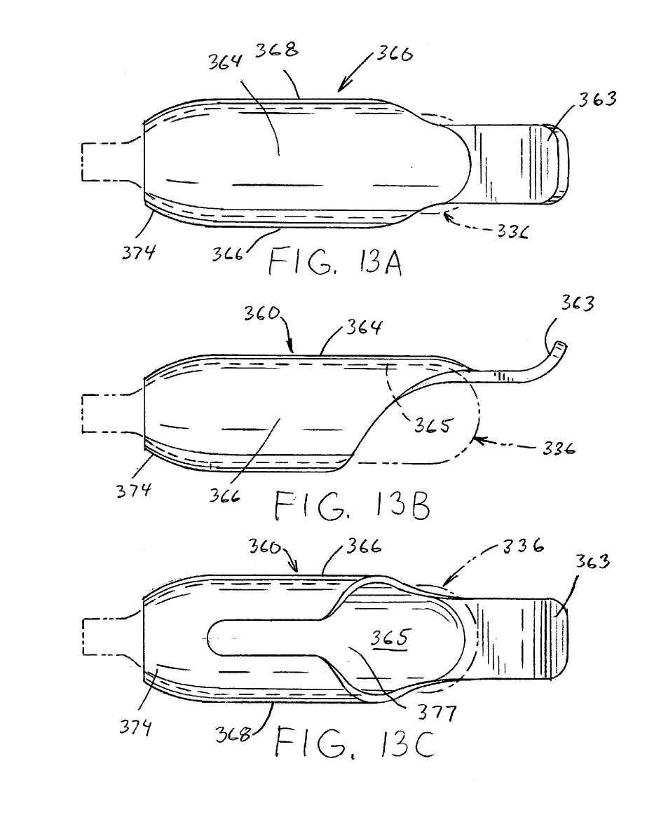

FIGS. 11A, 11B, 12A, 12B, 13A, 13B, and 13C show alternative embodiments of the present invention. Features of the alternative embodiments that are substantially similar to features of the embodiment illustrated in FIG. 1 and described above are indicated by similar reference number in a different 100 series. In this regard, the embodiment illustrated in FIG. 11A is referenced by 100 series numbers, the embodiment illustrated in FIG. 12A is referenced by 200 series numbers, and the embodiment illustrate in FIG. 13A is referenced by 300 series numbers. Features of the alternative embodiment features can be understood from the description of similarly numbered features described above.

Referring now to FIG. 11, a device 110 includes a tool 160 that has two rails or ribs 181. Ribs 181 each extend from opposite sides of prying bit 163 toward end 174. In one embodiment, ribs 181 are configured to be attachable to a corresponding receiver (not shown) that can be mounted on a bike, such as under the seat. Preferably, the receiver is configured such that ribs 181 can be quickly snapped in place as tip 138 is positioned within an opening formed on a bracket (not shown, but similar to bracket 22) mounted to the bike. In this manner, device 110 is configured such that it can be quickly attached and detached from a bicycle. In one embodiment device 110 is retained on a bike solely by the receiver and does not engage, or have its position determined by, a bracket.

Referring now to FIGS. 12A and 12B, according to another alternative embodiment, a device 210 includes a body 272. Body 272 can be configured to provide mechanical strength to tool 260 such that tool 260 can be used with cartridge 236 to change a tire. Body 272 can also be configured to engage a slide-on or snap in receiver as described above.

Referring now to FIGS. 13A and 13B, according to another alternative embodiment, body 364 smoothly extends into walls 366 and 368 can also be configured to engage a slide-on or snap in receiver as described above.

The present invention is generally applicable to repair kits for bicycles and more specifically to a combined tool for repairing a tire. In this regard, It can be advantageous to use device 10 to remove and inflate a tire because of the convenience and speed provided by the combined functionalities of device 10. Additionally, device 10 reduces the possibility that the user will misplace a tool and thus lose critical race time. Furthermore, even used separately, tool 60 and cartridge 36 are configured to be assembled as part of kits 20 and this provided light weight and aerodynamic repair kit. While the present invention has been illustrated and described with reference to preferred embodiments thereof, it will be apparent to those skilled in the art that modifications can be made and the Invention can be practiced in other environments without departing from the spirit and scope of the invention, set forth in the accompanying claims.

Having described the invention, the following is claimed:

1. A device for repairing bicycle tires, said device comprising:
a canister of compressed gas, and
a tool for removing tires

2. The device according to claim 1, wherein the tool includes a bit for prying and a housing that is configured to engage the canister.

3. The device according to claim 1, wherein the tool is configured to be detached from the canister of compressed gas.

4. The device according to claim 3, wherein the tool is configured such that the housing can be utilized as a lever when the tool is not engaged with the canister.

5. The device according to claim 3, wherein the housing is configured such that it cannot be effectively utilized as a lever when the tool is not engaged with the canister.

6. The device according to claim 1, wherein the canister and the housing together are configured to be utilized as a lever when the tool is used for removing tires.

7. The device according to claim 1, wherein the tool is attached to the canister such that the canister and the tool together form a tire lever.

8. A tire lever for removing a tire from a wheel, the tire lever comprising:
a tool portion configured to engage a tire attached to a rim such that the tire can be moved to disengage a bead portion of the tire from the rim.
a canister,
the tool portion being attached to the canister such that the canister forms the handle of a tire lever.
